(19) United States
(12) Patent Application Publication
(10) Pub. No.: US 2011/0149068 A1
(43) Pub. Date: Jun. 23, 2011

(54) APPARATUS FOR THREE-DIMENSIONALLY MEASURING OBJECT SHAPE

(75) Inventors: Seong-Ho SON, Daejeon (KR); Hyuk-Je Kim, Daejeon (KR); Jong-Moon Lee, Chungbuk (KR); Soon-Ik Jeon, Daejeon (KR)

(73) Assignee: ELECTRONICS AND TELECOMMUNICATIONS RESEARCH INSTITUTE, Daejon (KR)

(21) Appl. No.: 12/788,358

(22) Filed: May 27, 2010

(30) Foreign Application Priority Data
Dec. 21, 2009 (KR) 10-2009-0128483

(51) Int. Cl. H04N 7/18

(52) U.S. Cl. 348/135; 348/E07.085

(57) ABSTRACT

An apparatus for three-dimensionally measuring an object shape includes: a number of line lasers configured to emit laser lines to a subject to be measured and create a closed-curve shape related to a sectional contour line of the subject; and a camera configured to obtain an image of the created closed-curve shape.

### CROSS-REFERENCE(S) TO RELATED APPLICATIONS

The present application claims priority of Korean Patent Application No. 10-2009-0128483, filed on Dec. 21, 2009, which is incorporated herein by reference in its entirety.

### BACKGROUND OF THE INVENTION

1. Field of the Invention

Exemplary embodiments of the present invention relate to an apparatus for measuring the shape of an object; and, more particularly, to an apparatus for three-dimensionally measuring the shape of an object.

2. Description of Related Art

In general, breast cancer refers to adenocarcinoma occurring in breasts, and is the most common type of cancer in women. Methods for diagnosing and treating breast cancer are studied extensively.

Currently, the most widely used method for early diagnosis of breast cancer includes clinical breast examination for detecting breast lumps, and mammography for more detailed examination. However, the mammography is controversial because frequent or excessive exposure to X-rays may harm the human body. Other types of methods include microwave tomography, which uses microwaves that are not harmful to the human body, instead of X-rays.

The microwave tomography generates microwaves, which pass through the subject (breast), and backscattering of the scattered microwaves is analyzed to construct an internal image of the subject (distribution related to permittivity and conductivity) and detect tumors, if any, inside the subject. High-quality image construction, specifically three-dimensional image construction, by such a microwave imaging device requires scanning of the subject surface and measuring the accurate three-dimensional shape. However, measuring three-dimensional shapes by conventional scanning systems is complicated and difficult because the structure of the microwave imaging device requires that the subject (breast) be immersed in a liquid bath with radio transmitting/receiving antennas surrounding the subject.

### SUMMARY OF THE INVENTION

An embodiment of the present invention is directed to an apparatus for scanning the surface of a subject and measuring the three-dimensional shape.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for three-dimensionally measuring an object shape includes: a number of line lasers configured to emit laser lines to a subject to be measured and create a closed-curve shape related to a sectional contour line of the subject; and a camera configured to obtain an image of the created closed-curve shape.

The apparatus may further include a laser vertical driving mechanism configured to retain the line lasers at a predetermined angle and move the line lasers vertically in respective predetermined stages.

A closed-curve shape of the subject may be created by moving the line lasers in respective predetermined stages, an image of the created closed-curve shape may be obtained using the camera, and a three-dimensional shape may be reconstructed from images obtained in respective sages using a predetermined image processing algorithm.

### BRIEF DESCRIPTION OF THE DRAWINGS

FIG. 1 illustrates the arrangement of a microwave imaging apparatus using a camera to obtain images in accordance with an embodiment of the present invention.

FIG. 2 illustrates the operating principle of an apparatus for three-dimensionally measuring the shape of an object in accordance with an embodiment of the present invention.

FIG. 3 illustrates the operating principle of an apparatus for three-dimensionally measuring the shape of an object in accordance with another embodiment of the present invention.

FIG. 4 illustrates operation for obtaining an image of the subject by the right camera in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

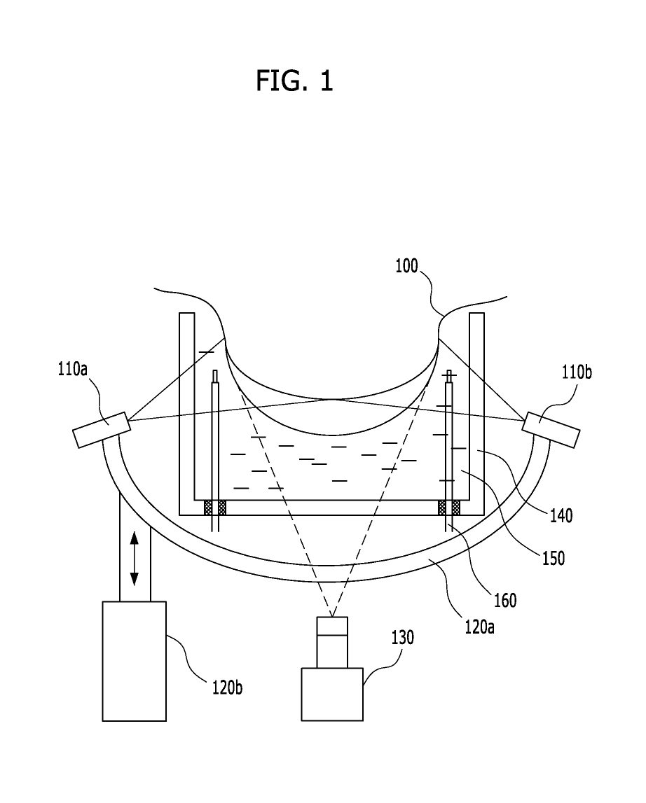

FIG. 1 illustrates the arrangement of a microwave imaging apparatus using a camera to obtain images in accordance with an embodiment of the present invention.

As shown in FIG. 1, the three-dimensional object shape measurement apparatus for microwave imaging includes a subject (breast) 100, which is to be examined to find any tumor, a number of line lasers 110a and 110b configured to form a scan shape around the subject 100, a laser vertical driving mechanism 120a and 120b, and a camera 130 positioned in front of the subject 100 to obtain a closed-curve shape formed by the line lasers 110a and 110b.

The line lasers 110a and 110b are configured to emit laser lines to the subject (breast) to create a closed-curve shape. The camera 130 is configured to obtain an image of the created closed-curve shape.

The laser vertical driving mechanism 120a and 120b includes a line laser retaining unit 120a configured to retain and hold the line lasers 110a and 110b at a predetermined angle and a driving unit 120b configured to directly drive the retaining unit 120a vertically.

It will be assumed that different sections of the subject 100 are to be measured continuously, including a first section and a second section positioned at a predetermined distance from the first section. Then, the driving unit 120b vertically drives the line lasers 110a and 110b so that they are moved from the first section to the second section.

Specifically, the driving unit 120b initially moves the line lasers 110a and 110b to the first section position. After the movement is completed, the camera 130 obtains an image of the first section.

The driving unit 120b then moves the line lasers 110a and 110b to the second section position by a predetermined distance, and the camera 130 obtains an image of the second section.

Those skilled in the art can understand that the present invention is not limited to the above-mentioned assumption (i.e. first and second sections of the subject (breast) 100 are photographed to obtain closed-curve images), and images of a plurality of sections at a predetermined distance from each other can be taken repeatedly to obtain more detailed closed-curve images of the subject shape. In addition, images obtained through the above-mentioned process can be analyzed based on a predetermined image processing algorithm to reconstruct a three-dimensional shape.

FIG. 1 illustrates a bath 140, a liquid 150, and radio transmitting/receiving antennas 160 to facilitate understanding of the structure of the mechanism in accordance with the present invention and clarify the characteristics of the present invention. These components will now be described briefly.

The apparatus for diagnosing breast cancer using microwaves shown in FIG. 1 includes a predetermined number of transmitting/receiving antennas 160 inside a bath 140 filled with a liquid. It will be assumed that there are sixteen transmitting/receiving antennas. The sixteen transmitting/receiving antennas #1, #2 . . . , #16 are arranged along a circle, and the subject 100 is inserted in the middle.

The antenna #1 transmits a microwave, and the remaining fifteen antennas #2, #3 . . . , #16 receive the scattered microwave. Information regarding the magnitude and phase of the microwave received by the fifteen antennas #2, #3 . . . , #16 is obtained. Thereafter, the antenna #2 transmits a microwave, and the remaining fifteen antennas #1, #3, #4 . . . , #16 receive the scattered microwave. Information regarding the magnitude and phase of the microwave received by the fifteen antennas #1, #3, #4 . . . , #16 is obtained.

The same process is repeated up to the antenna #16. Information obtained through the repeated process is subjected to microwave backscattering analysis to construct sectional images of the breast, so that any adenocarcinoma inside the subject 100 can be detected and positioned.

In order to display an image showing the position of the diagnosed adenocarcinoma, it is important scan the surface of the subject 100 and measure the correct three-dimensional shape.

Therefore, the present invention employs line lasers 110a and 110b, a vertical driving mechanism 120a and 120b, and a camera 130 for obtaining images. The center of the camera 130 is brought into coincidence with a point lying a predetermined distance from the centers of the line lasers 110a and 110b, and the laser vertical driving mechanism 120a and 120b is moved in a direction parallel with the camera 130 to obtain images.

The present invention provides an apparatus for measuring the three-dimensional shape of the subject (breast) by processing images obtained by the camera 130 based on a predetermined image processing algorithm.

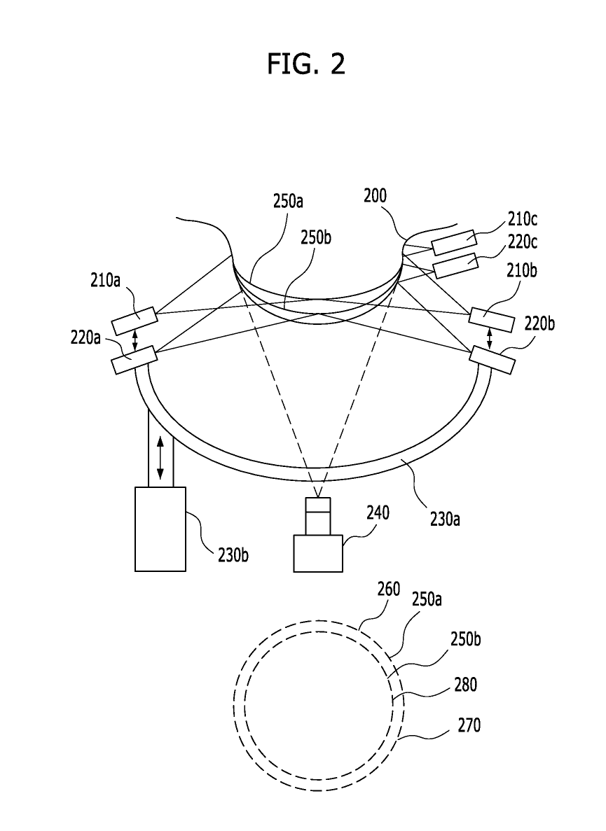

FIG. 2 illustrates the operating principle of an apparatus for three-dimensionally measuring the shape of an object in accordance with an embodiment of the present invention.

As shown in FIG. 2, a number of line lasers 210a, 210b, and 210c are arranged around the subject (breast) 200. The number of the line lasers 210a, 210b, and 210c depends on the size of the subject 200, and it will be assumed for convenience of description with reference to FIG. 2 that three line lasers 210a, 210b, and 210c are employed.

The camera 240 obtains an image of the closed-curve shape formed at the first section 250a of the subject by the line lasers 210a, 210b, and 210c.

Three-dimensional shape measurement of the subject 200 for microwave imaging requires that the line lasers 210a, 210b, and 210c are moved from the first section to other sections, which lie at predetermined distances from the first section. For example, the other sections include second, third, and fourth sections. The more sections are used, the more images are obtained by the camera 240 in respective stages so that a more precise three-dimensional shape of the subject 200 can be reconstructed.

It will be assumed for convenience of description with reference to FIG. 2 that images are obtained up to the second section 250b.

In order to obtain a closed-curve shape formed at the second section 250b, the line lasers 210b, 210b, and 210c need to be moved vertically from the first section to the second section 250b in parallel with the camera 240 by the line laser vertical driving mechanism 230a and 230b. As a result, the line lasers are at positions 220a, 220b, and 220c. The camera 240 then obtains an image of the closed-curve shape of the second section formed by the line lasers 220a, 220b, and 220c. The obtained image includes anomalies, which result from blocking of the line lasers by the radio transmitting/receiving antennas 160 (i.e. image discontinuity).

The gaps 260 between broken lines of the closed-curve shape 270 obtained from the first section 250a by the camera 240 are caused by the discontinuity. Similarly, the gaps between broken lines of the closed-curve shape 280 obtained from the second section 250b by the camera 240 are caused by the discontinuity. The gaps caused by the discontinuity are removed from images obtained from respective sections, which are then analyzed using a predetermined image processing algorithm to reconstruct a three-dimensional shape.

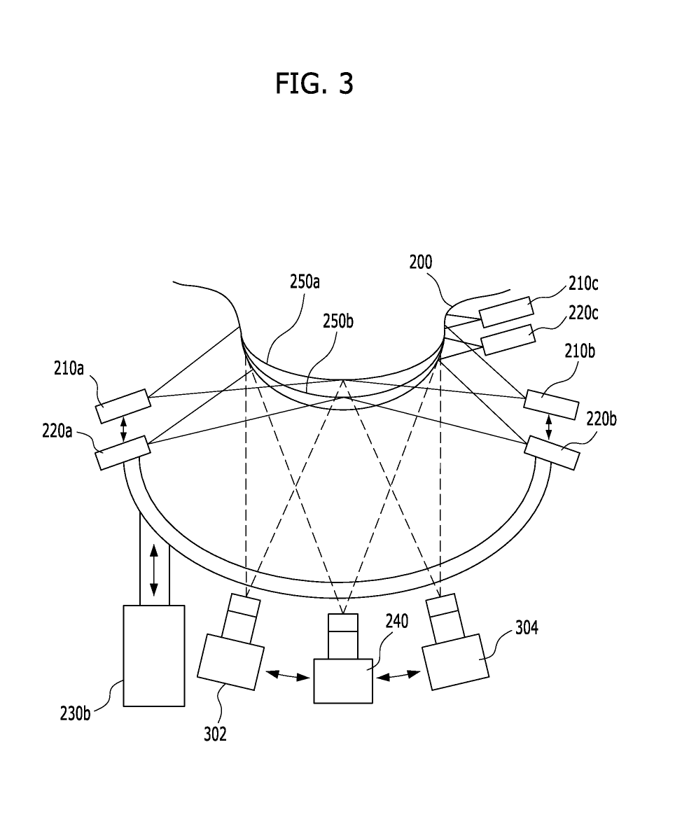

FIG. 3 illustrates the operating principle of an apparatus for three-dimensionally measuring the shape of an object in accordance with another embodiment of the present invention.

The embodiment shown in FIG. 3 is similar to the embodiment shown in FIG. 2, except that three cameras are employed to obtain a closed-curve shape.

Specifically, the shape of a subject 200 is obtained using three cameras 240, 302, and 304 existing in different directions X, Y, and Z. The more cameras are directed to the object in different directions, the more precise images can be obtained.

The subject (breast) 200 may come in various shapes, including one spreading toward armpits, flat one, sagging one, etc. Therefore, a more precise three-dimensional shape of the subject 200 can be obtained when left and right cameras 302 and 304 are additionally used than when the front camera 240 is solely used.

Those skilled in the art can understand that, although it has been assumed in the description with reference to FIG. 3 that three cameras are used, the number of cameras is not limited thereto, and can be varied in respective situations, considering that the more cameras are used, the more precise images are obtained.

The operation for obtaining a closed-curve shape by the left and right cameras 302 and 304 is the same as the operation for obtaining a closed-curve shape by the front camera 240 described with reference to FIG. 2. It is to be noted, however, that, since three cameras are used in accordance with the embodiment illustrated in FIG. 3, three images are obtained from each of the predetermined sections, including first and second sections.

Specifically, the three images includes a left image of the subject 200 obtained by the left camera 302, a right image of the subject 200 obtained by the right camera 304, and a front image of the subject 200 obtained by the front camera 240.

The three images (left, right, and front images) obtained in respective stages need to be combined into a single closed-curve image in order to obtain a complete closed-curve shape of the subject.

Considering that the three cameras 240, 302, and 304 are directed to the subject at different angles, the front camera 240 is designated as the reference camera.

The angles at which the left and right cameras 302 and 204 view the subject need to be calculated using a trigonometric function so that the same closed-curve image of the subject 200 is created as when the subject 200 is viewed from the front camera 240. The created images are processed using a predetermined algorithm to construct a three-dimensional shape.

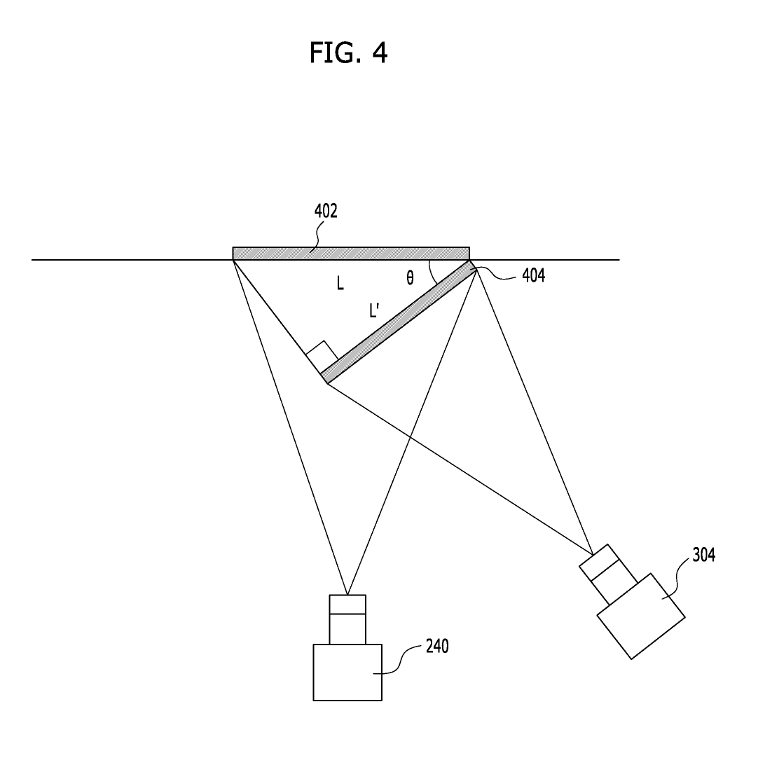

FIG. 4 illustrates operation for obtaining an image of the subject by the right camera in accordance with an embodiment of the present invention.

Specifically, FIG. 4 illustrates a process of obtaining a right image of the subject 200 using the right camera 304 shown in FIG. 3, and the same process can be used to obtain a left image of the subject 200 using the left camera 302.

The cameras 240, 302, and 304 obtain closed-curve shapes formed at the subject 200 by a number of line lasers 210a, 210b, and 210c.

The closed-curve shape of the subject 200, when viewed from the front camera 240, appears on a plane 402, and the front camera 240 obtains the image.

The right camera 304 lies at a predetermined distance from the front camera 240 and thus has a different angle of view of the subject 200. Therefore, the closed-curve shape, when viewed from the right camera 304, appears on a plane different from that when viewed from the front camera 240. Specifically, the closed-curve shape of the subject 200 viewed from the front camera 240 appears on plane L 402, and the closed-curve shape of the subject 200 viewed from the right camera 304 appears on plane L′ 404, due to the above-mentioned angle of view.

The plane L′ 404, on which the closed-curve shape viewed from the right camera 304 appears, needs to be transformed as much as θ using a trigonometric function so that it is equivalent to the plane L 402, on which the closed-curve shape viewed from the front camera 240 appears, as defined by Equation 1.

$$L = {L}^{′} \times \frac{1}{cos θ} \qquad Eq . 1$$

As mentioned above, the plane, on which the left closed-curve shape viewed from the left camera 302 appears, need to be similarly transformed as much as the angle of view so that it is equivalent to the plane L 402 on which the closed-curve shape viewed from the front camera 240 appears.

The obtained left, right, and front closed-curve images on the same plane are combined to obtain a single closed-curve image in order to create a complete closed-curve shape of the subject 200. The created image can be used to construct a three-dimensional shape based on a predetermined algorithm.

In accordance with the exemplary embodiments of the present invention, the apparatus for scanning the surface of a subject and measuring the three-dimensional shape uses line lasers, a vertical movement mechanism, and cameras so that, without interference with a liquid bath and radio transmitting/receiving antennas, the three-dimensional shape of the subject can be measured using simple mechanism and driving structure.

While the present invention has been described with respect to the specific embodiments, it will be apparent to those skilled in the art that various changes and modifications may be made without departing from the spirit and scope of the invention as defined in the following claims.

What is claimed is:

1. An apparatus for three-dimensionally measuring an object shape, comprising:
a number of line lasers configured to emit laser lines to a subject to be measured and create a closed-curve shape related to a sectional contour line of the subject; and
a camera configured to obtain an image of the created closed-curve shape.

2. The apparatus of claim 1, further comprising a laser vertical driving mechanism configured to retain the line lasers at a predetermined angle and move the line lasers vertically in respective predetermined stages.

3. The apparatus of claim 2, wherein the laser vertical driving mechanism comprises:
a line laser retaining unit configured to retain and hold the line lasers at a predetermined angle; and
a driving unit configured to directly drive the retaining unit vertically.

4. The apparatus of claim 2, wherein a closed-curve shape of the subject is created by moving the line lasers in respective predetermined stages, an image of the created closed-curve shape is obtained using the camera, and a three-dimensional shape is reconstructed from images obtained in respective sages using a predetermined image processing algorithm.

5. The apparatus of claim 1, wherein the camera comprises:
a front camera configured to obtain an image of a front closed-curve shape of the subject viewed from the front;
a right camera configured to obtain an image of a right closed-curve shape of the subject viewed from the right side; and
a left camera configured to obtain an image of a left closed-curve shape of the subject viewed from the left side.

6. The apparatus of claim 5, wherein planes on which the left and right closed-curved shapes appear are transformed using a trigonometric function to be equivalent to a plane on which the front closed-curve shape appears.
